(19) United States
(12) Patent Application Publication
(10) Pub. No.: US 2018/0253752 A1
(43) Pub. Date: Sep. 6, 2018

(54) MOBILE APPLICATION FOR ADVERTISING LOCAL DEALS AND PROMOTIONS, INVENTORY MANAGEMENT, MOBILE ORDERING, COUPON VENDING, MARKETING AND ANALYTICAL TOOLS FOR SMALL BUSINESSES

(71) Applicant: BrainVision Market Analytics Inc., Markham (CA)

(72) Inventors: Albert LAM, Markham (CA); Yefan WEI, Markham (CA); Xinqing LIAO, Markham (CA); Yaya YANG, Markham (CA); Sajid SHAIKH, Markham (CA); Lei SHEN, Markham (CA); Kenix PO, Markham (CA); Gerald WONG, Markham (CA)

(21) Appl. No.: 15/449,669

(22) Filed: Mar. 3, 2017

(51) Int. Cl. G06Q 30/02; G06Q 10/08; G06Q 30/06; G06Q 20/20; G06K 19/06; G06K 7/10; H04W 4/02

(52) U.S. Cl. CPC G06Q 30/0239; G06Q 10/087; G06Q 30/0633; G06Q 20/202; H04W 4/021; G06Q 30/0201; G06Q 30/0631; G06K 19/06028; G06K 7/10554; G06Q 30/0251

(57) ABSTRACT

The present invention is a mobile application that offers deals and promotions from a user's preference perspectives. The present invention can be used by store owners to manage their deals and promotions in real time and track the customer's activities that can help generate more revenue and cut down costs. The present invention can also be used by the end-user to find the best deals and promotions in user's proximity by a unique location-based predictive notification platform based on their buying habits or preference. The present invention simplifies the payment method by using the mobile device.

### FIELD OF THE INVENTION

The present invention relates generally to digital marketing, and especially to mobile applications for advertising local deals and promotions.

### BACKGROUND OF THE INVENTION

Large size retailers use sophisticated sales management systems to add, update, delete and maintain deals and promotions for the items in their stores. These systems are also used to categorize inventory and manage cash registry at the point of sale. Medium size retailers are not able to compete with either large or small retailers. They excel in niche markets and are challenged to promote their deals to the consumers and attract them to their stores. On the other hand, large chain retailers might not be able to localize their deals based on the demographics of individual neighborhoods. They administer their deals either countrywide or province-wide by the distribution of flyers and coupons. Their deals are not generally inclined to, nor customized by, geographical differences based on the demographics of the population.

Consumers are deal hunters, but they do not have a centralized platform wherein they can search and manage deals by item name, number, brand, discount percentage or retailer. They have to wade through generic flyers and coupons from different retailers. They also do not receive customized notifications for their sought merchandise, or wish lists.

The present invention is focused on small to medium sized retail businesses to give them accessibility to promote their businesses on mobile devices (cell phones and hand-held devices). The present invention simplifies the workloads of businesses and helps consumers to find deals and promotions in their neighbourhood.

### SUMMARY OF THE INVENTION

The present invention is a computer-implemented program for advertising local deals and promotions. It comprises of a retailer portal and an end-user portal, which are uniquely integrated to provide rapid advertising platforms. The retailer portal comprises of a real-time inventory tracking in a virtual store; an online ordering platform, where an end-user can put the orders; a mobile advertising platform that has the ability to create a flyer for deals and promotions; a learning program to detect the demographic difference and buying habits using statistics and big data analytics to promote the deals which attract the end-user, a computer-implemented program to review the end-users behavior and prepare a report for the retailer, and a P.O.S system to manage the sales in both the physical and the virtual store. The present system also provides a real-time tracking of the inventory of the items of the retailer.

The present invention is designed to eliminate the hassle of wading through paper flyers and coupons, where consumers do not always find what they need.

The present invention enables retailers and businesses to post special offers and deals and attract more customers. The present invention can solve the struggles of the businesses for promoting their business.

The small retailers can have an inventory of the items that are available in a store and can create a virtual store in their profiles. The present invention also has an online ordering platform for the retailers, and the end-user can order the items in the virtual store.

The present invention incorporates barcode technology tied to its database to capture and save selected items. Exclusive coupons are also tied to the database of the present invention.

The deals and promotions from the flyers, which the retailers created, are available in the end-user mobile phones or handheld devices. The flyers can be viewed and searched by the end-user. The application of the present invention has access to the previously searched flyers without having access to the internet. The end-users can view and search the deals in the offline mode of the application.

The end-users (shoppers) can create their own personal profile; save items of their interests; receive deal recommendations based on other users' interests; view stores details and deals; navigate to the closest stores; share offers they liked to their network, and receive notifications according to their preferences.

The present invention offers user-friendly protocol for navigation, searching, matching, setting, viewing, saving information, and sharing information for the retailers and end-users.

The present invention also provides a mobile advertising platform that can list retailers' deals with their GPS locations. The present invention is not only convenient, personal, and relevant to the end-users but is also a reasonably priced mobile advertising solution for retailers. It provides a low cost and efficient solution for small to medium sized retailers enabling them to remain competitive to attract end-users. Retailers can advertise up-to-the-minute deals and send out unique offers to certain segments of customers without a need to print and distribute paper flyers door-to-door.

The present invention presents deals from end-users' favorite brand name stores; collects deals from the retail stores in their neighborhood; enables users to search for closest local deals, and enables retailers to manage their promotions and deals.

Shopping application of the present invention sends personalized alerts for items on-sale in stores of interest of the user. The user can set the alerts to be sent out according to the item price, a specific item and/or brand, and proximity of the store. A user can either use predesigned templates available on the system.

Matching the end-users purchase preferences with local promotions is the key function of the present invention, since it lets the end-users to find what they want at the right price and the right location. The whole idea of the present invention is to bring end-users to the physical location wherein the retailer is still running their business inside the brick and mortar store. One objective of the present invention is to minimize printing and distribution of the paper form of advertisement. Another objective of the present invention is to maximize the impact of the live advertisement of great deals and promotions using a real time mobile advertising platform via mobile devices.

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a schematic diagram of the present invention;

FIG. 2 shows a schematic diagram of the structure of the present invention;

FIG. 3 shows a schematic diagram of the retailer portal of the present invention;

FIG. 4 shows a schematic diagram of the real-time tracking inventory of the present invention;

FIG. 5 shows a schematic diagram of the online ordering platform of the present invention;

FIG. 6 shows a schematic diagram of the end-user behavioral program of the present invention;

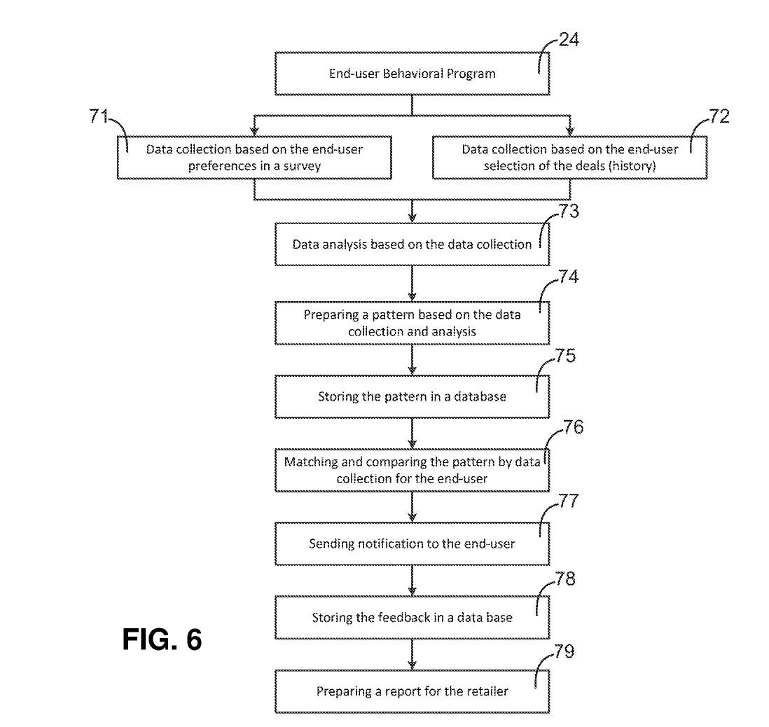

FIG. 7 shows a schematic diagram of the location-based notification platform of the present invention;

FIG. 8 shows a schematic diagram of the tracking and matching program of the present invention, and

FIG. 9 shows a schematic diagram of the discount coupon and barcode finder of the present invention.

The figures are not intended to be exhaustive or to limit the present invention to the precise form disclosed. It should be understood that the invention can be practiced with modification and alteration, and that the disclosed technology be limited only by the claims and equivalents thereof.

### DETAILED DESCRIPTION OF PREFERRED EMBODIMENTS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

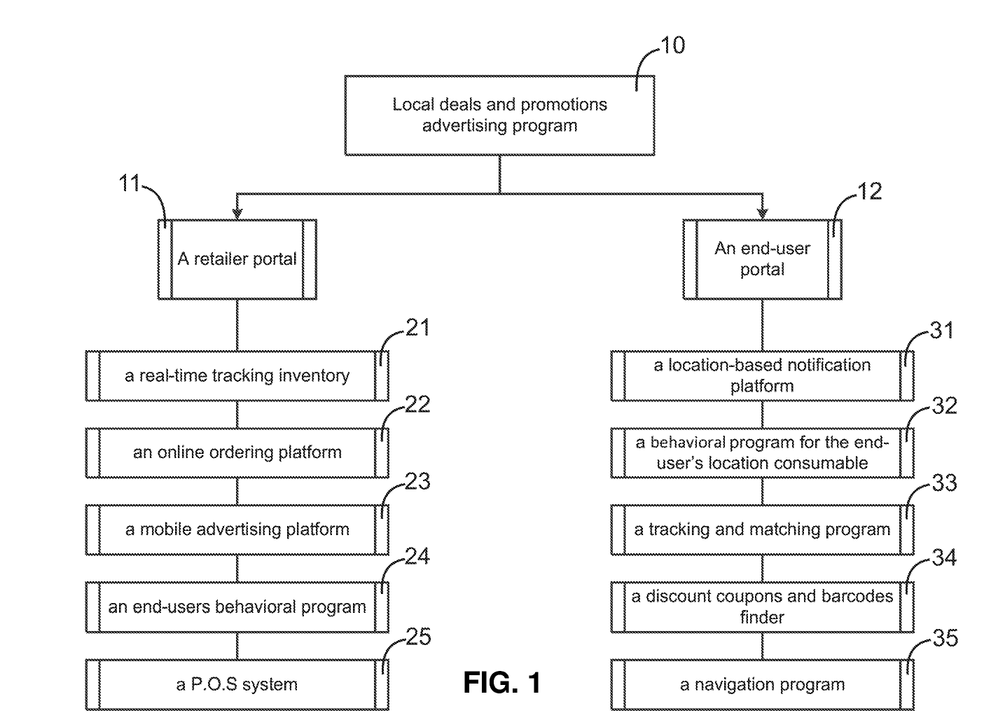

As shown in FIG. 1, the present invention is a computer-implemented program for advertising local deals and promotions 10. It comprises of a retailer portal 11 and an end-user portal 12. End users can have end-user profiles in the end-user portal 12 and retailers can have retailer profiles in the retailer portal 11. The retailer portal 11 comprises of a real-time inventory tracking system 21 of the items that are available in a store, thereby creating a virtual store. In addition, it has an online ordering platform 22 through which an end-user can order items. The system also comprises of a mobile advertising platform 23 that has the ability to create a flyer for deals and promotions. In addition, the system comprises of a learning program to analyze demographics and buying habits of the end-user to promote deals which attract the end-user and a computer program to review the end-users' behavior 24 and prepare a report for retailers. It also has a P.O.S. system 25 to manage the sales in the virtual store.

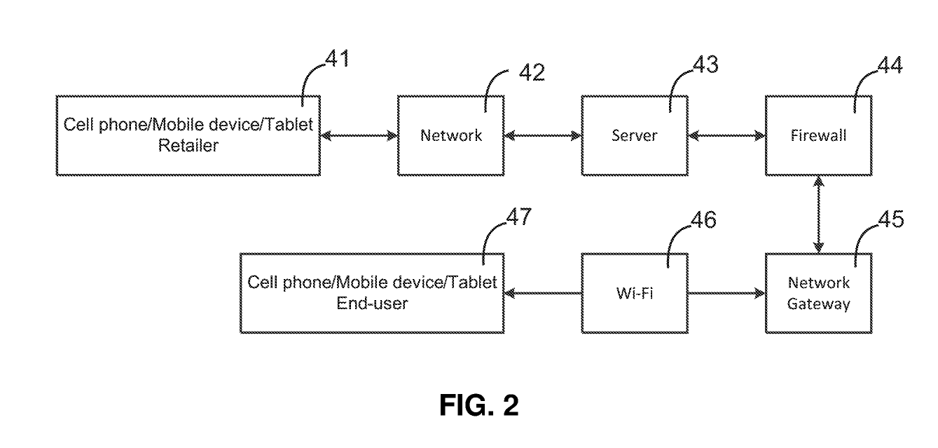

FIG. 2 shows the schematic diagram of the structure of the present invention. The retailer connects with the end-user through a cell phone, mobile device or tablet 41, 47. The cell phone, mobile device or tablet of the retailer 41 connects to a network 42 having a server 43 which is protected by a firewall 44 to the network gateway 45. The cell phone, mobile device or tablet of the retailer 41 can be connected to the cell phone, mobile device or tablet of the end-user 47 by a Wi-Fi connection 46.

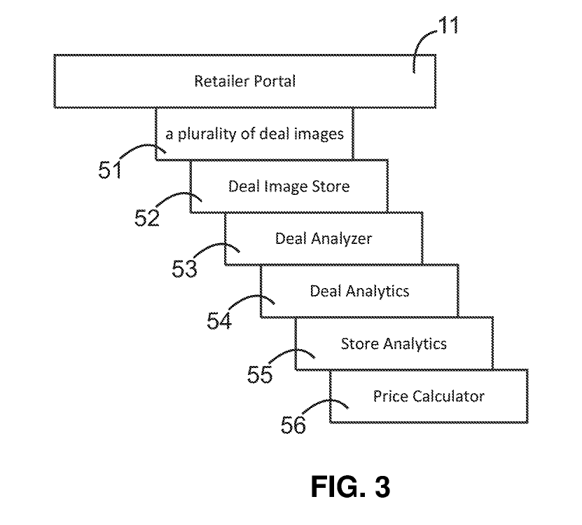

As shown in FIG. 3, the retailer portal 11 further has a plurality of deal images 51 which stores in a deal image store 52. The retailer portal 11 can be equipped with camera of the mobile device to facilitate real time posting of the deals in the platform. The retailer portal 11 further has deal analyzer 53, deal analytics 54, store analytics 55 and price calculator 56.

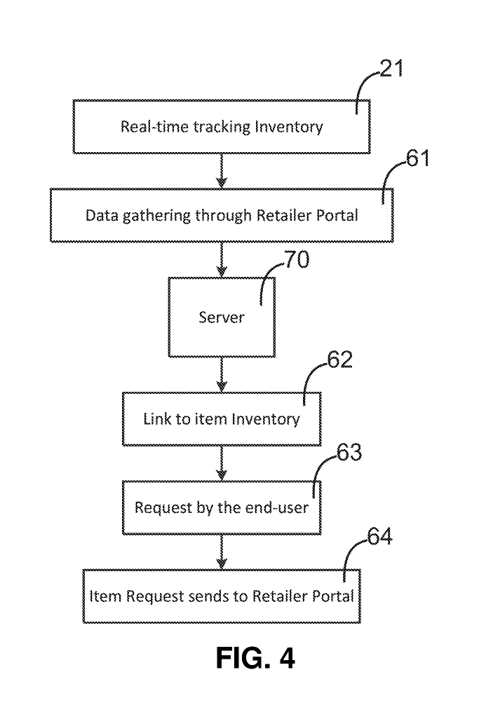

As shown in FIG. 4, the real-time inventory tracking system 21 of the present invention dynamically tracks all items in the inventory list and assigns a specific barcode for each item. The system 21 also gathers data 61 from retailer portal, save the gathered data in a server 70 and links to item inventory 62 which requested by the end-user 63. The system also sends the item request to the retailer portal 64. A monitoring system having a barcode reader configured to read barcodes from items located within the inventory updates the inventory in real time and reports changes in the inventory. As the item is sold thru the platform, the monitoring system calculates the inventory of the item in real time and once the quantity on sale is finished; the monitoring system deletes the sale items from the database.

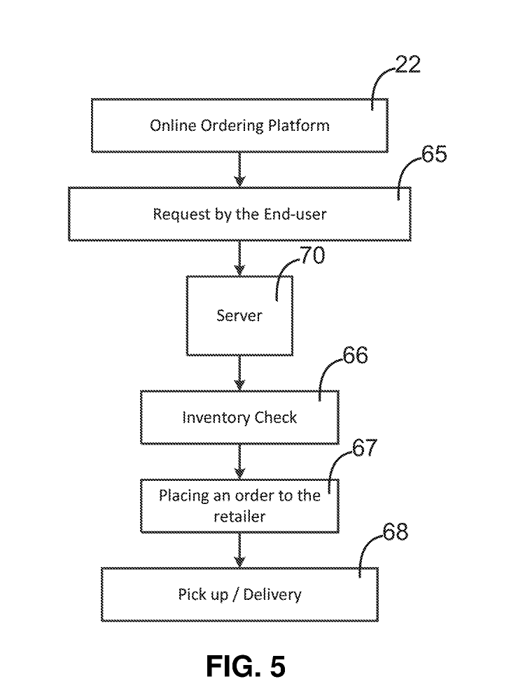

As shown in FIG. 5, the online ordering system 22 of the retailer portal allows retailers, in particular, small size retailers, to post the items that are available for pickup in the store or available for delivery. The end-users could order the items 65, 67 through the online ordering system 22 and choose to pick up at the store or request delivery 68. This function could help the end-users to check the availability of items (inventory checking) 66 and help the retailers to manage their products. The online ordering system facilitates the ordering process. The end-user can order the deal or the item through the present invention platform.

The mobile advertising platform 23 of the present system has the ability to create flyers for deals and promotions for any retailer. The platform contains non-static digital images. A user-friendly system allows retailers to create flyers dynamically and interactively. Through the mobile advertising platform 23 of the present system, the retailer can upload images to the retailer portal. The flyers can also be easily modified and updated. The retailers can create flyers and post or share them in their profiles or other social media applications, and change or delete them at any time. The platform has a plurality of pre-designed flyers that the retailers can choose from. The platform can also create professional flyers for low budget retailers.

The flyer created by the mobile advertising platform of the present invention is searchable by end-users. The information inside the flyer, such as the item name, price and the description is searchable by any program that has a search engine.

The computer-implemented program in the retailer platform reviews and screens the end-users' behavior 24 based on the items purchased and the location at which the items are purchased (data collection based on history) 72, and also data collection from the end-user preferences thru a survey 71. The program 24 also analyses the data collection 73 and preparing a pattern 74 based on the collected data and the analyzed data. The system 24 stores 75 the patterns in a database and matches and compares the patterns by the data collections 76. The system 24 sends notifications 77 to the end-user and also stores the feedback 78 in the database. The system 24 also prepares a report 79 for the retailer. The report can be used by retailers to manage their store inventory according to the end-users' behavior. The report further has information such as successful promotions based on the quantity of purchased deals, age of end-users, gender, and the location of the end-users.

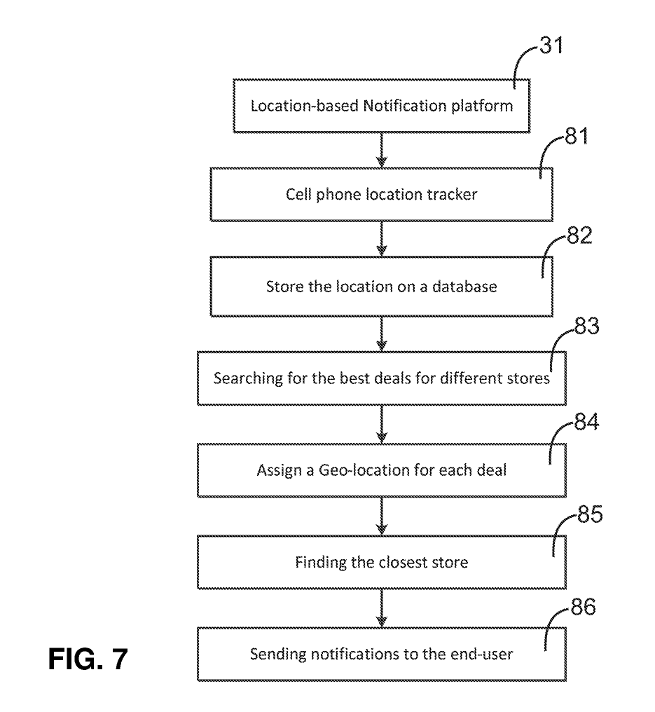

As shown in FIG. 7, the end-user portal also comprises of a location-based notification platform 31 to notify the end-user about any nearby deals. The platform 31 identifies nearby deals based on distance/location, convenience, and user preference. A computer-implemented program analyzes the end-users' locations and their purchasing behavior. The platform 31 tracks 81 the cell phone and the shopping preferences of end-users and identifies a list of items that match end-users' preferences. The platform stores the data in a database 82 and search throughout the data to find best deals 83. The platform assigns a geo-location for each deal 84 to finds the closest store 85. The platform sends notification 86 to notify the end-user about the closest store.

The location-based notification platform 31 monitors the geographic location of the end-user's mobile and communicates with the end-user with notifications when the geographic location of the end-user's mobile meets geo-location criteria related to the end-user's preference.

The end-user can set a certain distance range that he/she wants to receive possible type of deals. When the user is within the predefined distance to a retailer, the location-based notification platform 31 notifies the user if there is a matched deal.

The present location-based notification platform 31 notifies the end-user of (i) stores located close to the end-user and have items of his/her preference, and (ii) stores located within the end-users' future location and have items of his/her preference. Prediction of the preferred deals can be used for future locations based on geographical reference that have matched the similar characteristics of the deals.

In addition, a computer-implemented program searches throughout the list of the shopping preferences based on the past history of the end-user. It analyses the shopping preferences of the end-user based on the items and the location and creates a behavioral pattern to use in future matching.

The end-user portal 12 also comprises of a behavioral program for the end-user 32 to learn and understand the end-user consumption behavior. The behavioral program has the capacities of storing the attributes of the shopping behavior of the users based on the histories of usage. A method of demographic and psychographic profiling will include individual's likes and dislikes as well as preferences in retail items like price, brands, stores, sizes, proximity, etc. The profile of the users is indexed by the user's residence or work location and the user's shopping behaviour and preference based on pricing, branding, proximity and convenience of locations. The system has a built in artificial intelligence analyses system for marketing based user tracker statistics. The learning program is a statistical model and constantly evolving based on the profile indexes of the users.

The computer-implemented program of the present invention analyzes the end-user's location consumable behavior and favorite. The program uses of statistical algorithms to analyse the geographical location in consumable behaviour based on the past experience and predict the next multiple moves in their choices. It involves psychological research and artificial intelligence.

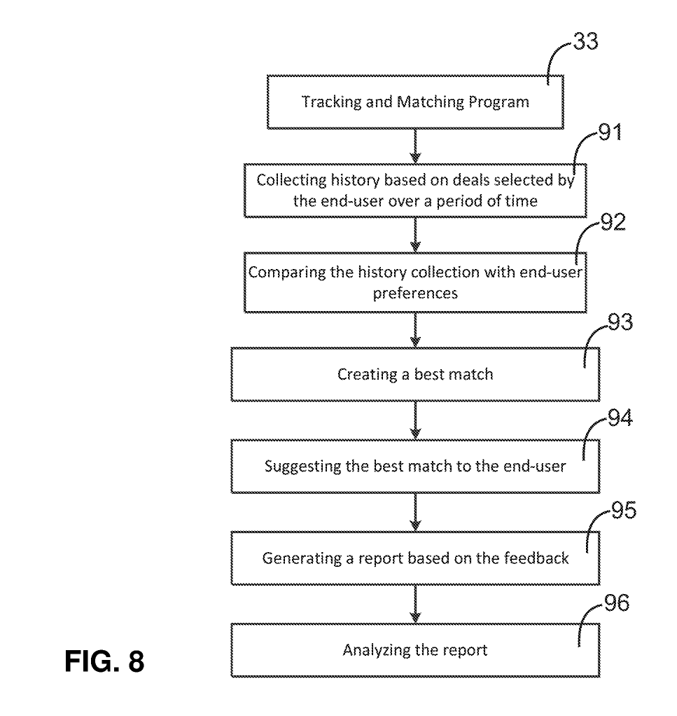

As shown in FIG. 8, the computer-implemented program tracks the shopping preferences 33 of the end-user and matches a list of similar items based on the shopping preferences. The program 33 collects 91 end-user's preferences, favorites, likes and dislikes and find outs 92 and suggests (create a best match) a list of similar items 93, which have better deals and promotions. The present program 33 reviews the end-user's profile and matches the items in the virtual store of the retailer with the user preferences. The program also suggests the best match to the end-user 94. The program 33 also prepares a report for the retailer 95 about the favorite items bought by the end-users based on the location and analyzes the report 96.

The computer-implemented program of the present invention searches throughout the shopping preference of the end-user to find discount coupons and barcodes 34 for the end-user from the sellers or manufacturers website. It has the ability to search for coupons both on the websites and databases. The program can add the discount coupons and barcodes to the item in order to reach to the user's desired price. The program of the present invention automatically searches for coupons when item is scanned or searched. A pop-up is created with a bar code or QR code that is scanable and when scanned at the register deducts the coupon amount. The retailers can then collect all these coupon barcodes in their data bases and collect the money from the vendor/manufacturer. The bar codes are generated based on the manufacturer and their campaign for tracking purposes. Barcodes are used by manufactures and the present invention uses the barcodes to develop its unique barcodes that match to the genuine ones used by the manufacturers.

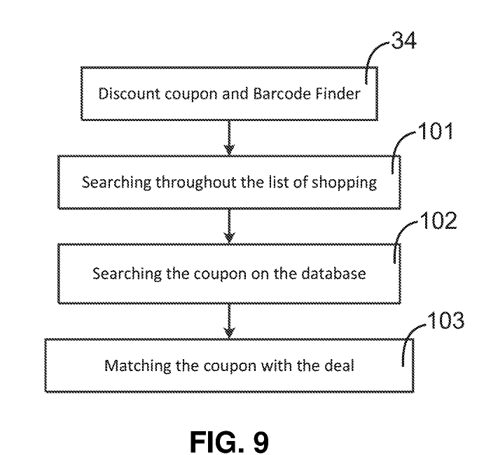

As shown in FIG. 9, in addition, a computer-implemented program searches throughout the list of the shopping preferences 101 to find discount coupons and barcodes to send to the end-user. The program 34 searches the requested coupons on the relevant databases 102 and matches the requested coupons with the deals 103.

A navigation program 35 is used in the end-user portal to find the nearest locations to the end-user. The navigation program 35 navigates the end-user to the nearest location for the shopping preferences. The program uses GPS for accessing proximity and it is designed to offer and enhance the navigation by providing specific directions to the target location.

A method of setting up profiles: using the functional demographic and psychographic data screen through the account manager or filtering or by typing in key words. The present invention captures the profile of the users by planting cookies in the mobile device to gather information about the usage and choices for selecting deals.

Customer-based web mobile application using customer profiling selection technology. The profile is an indexing algorithm that summarizes and describes the end-user.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1. A computer-implemented program for advertising local deals and promotions, inventory management, mobile ordering, coupon vending, marketing and analytical tools for a small retailer which comprises of a retailer portal and an end-user portal,
a) said retailer portal comprises of:
i) a real-time tracking inventory of a plurality of items in a store to create a virtual store;
ii) an online ordering platform which an end-user orders said items;
iii) a mobile advertising platform which has the ability to create a flyer for a deal;
iv) a computer-implemented program to review the end-users behavior and prepare a report for the retailer, and
v) a P.O.S system to manage the sales in both a physical store and the virtual store;
b) said end-user portal comprises of
i) a location-based notification platform to notify the end-user about nearby deals;
ii) a computer-implemented program to analyze the end-user's location consumable behavior and favorite;
iii) a computer-implemented program to track a shopping preference of the end-user and match a list of similar items based on the shopping preference;
iv) a computer-implemented program to search throughout the shopping preference to find discount coupons and barcodes for the end-user; and
v) a computer-implemented program to navigate the end-user to the nearest location for the shopping preferences of the end-user.

2. The computer-implemented program of claim 1, wherein said retailer portal further has a camera to facilitate real time posting of the local deals in said retailer portal.

3. The computer-implemented program of claim 1, wherein said real-time tracking inventory tracks a plurality of items in an inventory list and assigns a specific barcode for each said item, and wherein said real-time tracking inventory further has a barcode reader configured to read barcodes from items located within said inventory and updates said inventory in a real time and reports changes in a database.

4. The computer-implemented program of claim 1, wherein said mobile advertising platform contains a plurality of non-static digital images which allows retailers to create a flyer dynamically and interactively.

5. The computer-implemented program of claim 1, wherein said computer-implemented program to review the end-users behavior gathers data based on the items purchased by said end-user and a location at which the items are purchased and from the end-user preferences thru a survey.

6. The computer-implemented program of claim 1, wherein said computer-implemented program to review the end-users behavior analyses the data collection and preparing a pattern based on the collected data.

7. The computer-implemented program of claim 1, wherein said location-based notification platform identifies nearby deals based on distance/location, convenience, and user preference.

8. The computer-implemented program of claim 1, wherein said wherein said location-based notification platform notifies said end-user when a geographic location of said end-user's mobile meets geo-location criteria related to said end-user's preference.

9. The computer-implemented program of claim 1, wherein said computer-implemented program to analyze the end-user's location consumable behavior and favorite stores the attributes of the shopping behavior of said end-users based on the histories of usage.

10. The computer-implemented program of claim 1, wherein said computer-implemented program to track a shopping preference of said end-user and match a list of similar items based on the shopping preference collects and reviews said end-user's preferences, favorites, likes and dislikes and find outs and suggests a list of similar items, which have a better deal and promotion.

11. The computer-implemented program of claim 1, wherein said computer-implemented program to search throughout the shopping preference to find discount coupons and barcodes, wherein said program adds the discount coupons and barcodes to the item in order to reach to a user's desired price.
